(19) United States
(12) Patent Application Publication
(10) Pub. No.: US 2024/0221054 A1
(43) Pub. Date: Jul. 4, 2024

(54) Fashion Personality Prediction and Clothing Recommendation Method and Device Based on Social Networks

(71) Applicant: Soochow University, Suzhou (CN)

(72) Inventor: Zhebin XUE, Suzhou (CN)

(21) Appl. No.: 18/358,237

(22) Filed: Jul. 25, 2023

(30) Foreign Application Priority Data
Dec. 27, 2022 (CN) 202211690323.9

(51) Int. Cl. G06Q 30/0601; G06Q 50/00

(52) U.S. Cl. CPC G06Q 30/0631; G06Q 50/01

(57) ABSTRACT

The present invention discloses a fashion personality prediction and clothing recommendation method based on social networks, comprising: collecting language feature data of users in social networks; obtaining all proportional preferences of users' fashion personality types based on a fashion personality test scale; establishing a relationship model between language features and fashion personality types using machine learning algorithms; extracting clothing features, selecting clothing samples, quantifying style of clothing samples, and matching design style of clothing samples; obtaining user's preference values for clothing sample styles; constructing a clothing design model by combining relationship between fashion personality types and clothing style preference values, and correspondence between clothing styles and design elements with user's language feature and fashion personality type relationship model. More comprehensive and efficient exploration of consumers' personalized aesthetic preferences is enabled with significant improvements in model accuracy. Fashion personality is also defined, which helps clothing companies develop precise marketing strategies.

### CROSS-REFERENCE TO RELATED APPLICATION

The present application claims priority from the Chinese Invention Patent Application No. 202211690323.9 filed on 27 Dec., 2022, and the disclosure of which is incorporated herein by reference in its entirety.

### FIELD OF THE INVENTION

The present invention relates to the field of preference data prediction technology, and in particular to a fashion personality prediction and clothing recommendation method and device based on social networks

### BACKGROUND OF THE INVENTION

The existing methods and technologies for clothing recommendation mainly include: (1) extracting user needs and preferences based on consumer evaluation data; However, collecting user evaluation data is challenging as it requires prior product usage experience, and the consumer's language often lacks standardization and clarity, which can hinder effective extraction of demand information. (2) The membership relationship between clothing and evaluation elements (such as style, design, fabric attributes, etc.) is constructed by means of expert sensory evaluation (scoring). But this method ignores the individual needs of consumers. (3) Clothing recommendations are made based on the similarity of products, as well as users' historical purchase records.

However, the current methods rely on users' past clothing consumption behavior, leading to sparse data and cold start issues (limited or no relevant data). These methods primarily focus on clothing itself while neglecting consumers' emotional needs, making it difficult to capture their true and stable intrinsic demands from a consumer perspective. The consequence is low design efficiency and recommendation accuracy.

### SUMMARY OF THE INVENTION

The purpose of this section is to outline certain aspects of the embodiments of the present invention and provide a brief introduction to some preferred embodiments. Simplifications or omissions may be made in this section, as well as in the abstract and title of the present application, to avoid ambiguity in their purpose. However, such simplifications or omissions cannot be used to limit the scope of the present invention.

In view of the existing problems mentioned above, the present invention is proposed.

Therefore, the present invention provides a fashion personality prediction and clothing recommendation method and device based on social networks, which solves the problems of data sparsity and cold start (related data is scarce or missing) in current recommendation and prediction systems. It addresses the difficulties in capturing consumers' true and stable inner needs from their perspective, and the low efficiency and accuracy of design and recommendation.

In order to solve the above technical problems, the present invention provides the following technical solutions:
The first aspect:
collecting feature data of language used by the users in social networks;
establishing a fashion personality test scale, and obtaining the fashion personality test scale, all the proportional preferences of fashion personality types of the users;
developing a relationship model between users' language characteristics and fashion personality types using machine learning algorithms;
extracting clothing features, screening clothing samples, quantifying the style of said clothing samples, and then matching the design style of the clothing samples;
obtaining the users' style preference values for clothing samples; and
based on the correspondence between fashion personality types and clothing style preference values, as well as the correspondence between clothing styles and design elements, establishing a clothing design model by combining the relationship model between users' language characteristics and fashion personality types for prediction and recommendation.

As a preferred embodiment of the fashion personality prediction and clothing recommendation method based on social networks disclosed in the present invention, where the developing a relationship model between users' language characteristics and fashion personality types using machine learning algorithms further includes:
obtaining a set of first-personality language feature elements (m) by combining the number of words used by the users in different types of social text and an emotion dictionary;
obtaining the correlation coefficients between the personality language feature elements of users and the fashionable personality types, and filtering out personality language feature elements with strong correlation coefficient, where
the personality language feature elements with strong correlation coefficient are used to establish the relationship model.

As a preferred embodiment of the fashion personality prediction and clothing recommendation method based on social networks disclosed the present invention, where the establishing a fashion personality test scale includes:
collecting a large number of daily product images related to fashion, and generating personality-based descriptive vocabulary expressing fashion styles based on the images;
after screening all the personality-related vocabularies, classifying all the personality-related vocabularies by clustering algorithm combined with semantics, where each type corresponds to a fashion personality type, represented by p1, p2, . . . pk;
designing a series of fashion personality assessment questions based on text and images to explore the specific behaviors and psychological expressions of users with different fashion personalities in fashion-related activities, selecting, through significant difference analysis and reliability and validity testing, items that have discriminatory power for personality identification to form a fashion personality test scale;
furthermore, the obtaining, based on the fashion personality test scale, all the proportional preferences of fashion personality types of the users, comprising:
obtaining the first score set by scoring each personality type using the fashion personality test scale; and
comparing the scores of each personality type within the first score set with the number of questions to obtain the proportional preferences of fashion personality types P={p1,p2, . . . pk}.

As a preferred embodiment of the fashion personality prediction and clothing recommendation method based on social networks disclosed in present invention, where the filtering out personality language feature elements with strong correlation coefficient,, including:
reserving the feature elements involved in correlation coefficients greater than the first threshold as the key language feature set for fashion personality prediction index, expressed as:

$$T = \{ ti , tj , … , tw \} ( i < j < w ∈ \{ 1 , 2 , 3 , … , m \} )$$

that is, among m language feature elements, there are w (w<m) feature elements that have a strong correlation with fashion personality types.

As a preferred embodiment of the fashion personality prediction and clothing recommendation method based on social networks disclosed in the present invention, where the developing a relationship model between users' language characteristics and fashion personality types, including:
the input data is the key language features set Ti={t1, t2, . . . , tw}; and
the output data is a multidimensional matrix Qi={q1,q2 . . . , qk}, where
the multidimensional matrix Qi={q1, q2, . . . , qk} corresponds to the proportional preferences of personality types P={p1, p2, . . . , pk}.

As a preferred embodiment of the fashion personality prediction and clothing recommendation method based on social networks as disclosed in the present invention, where the quantifying the style of clothing samples and then matching the design style of clothing samples, including:
using nine-level semantic scale to score the style of clothing samples;
using, based on score statistics, triangular fuzzy numbers to characterize the style of various clothing samples, and calculating the degree of proximity, expressed as:

$$= ( \frac{{\sum }_{k = 1}^{n} {A}_{ijk 1}}{n} , \frac{{\sum }_{k = 1}^{n} {A}_{ijk 2}}{n} , \frac{{\sum }_{k = 1}^{n} {A}_{ijk 3}}{n} , )$$

where n represents the total number of experts participating in the evaluation, i denotes different clothing samples, and j represents pairs of adjectives for different clothing styles.

$${U}_{T} ( ) = \frac{ai - l}{m - l} + \frac{1}{2} \vert \frac{di - ai}{( m - l ) + ( di - ai )} - \frac{ai - ci}{( m - l ) + ( ai - ci )} \vert$$

where, [symbol] =(ci, ai, di), i=1,2, . . .,n; U_{T}( [symbol] ) represents the overall utility value of a triangular fuzzy number; n is the total number of experts participating in the experiment, and m and I are the upper and lower limits of the triangular fuzzy numbers, respectively;

$${S}_{T} ( ) = \frac{{U}_{T} ( \tilde{A} ) \cdot {U}_{T} ( \tilde{B} )}{max ( {U}_{T} ( \tilde{A} ) \cdot {U}_{T} ( \tilde{A} ) , {U}_{T} ( \tilde{B} ) \cdot {U}_{T} ( \tilde{B} ) )}$$

where, U_{T}(Ã) represents the overall utility value corresponding to the triangular fuzzy number Ã, U_{T}(\tilde{B})represents the overall utility value corresponding to the triangular fuzzy number \tilde{B}, and S_{T}( [symbol] ) denotes the proximity between A and B, i.e., the degree of closeness between the clothing sample and the clothing style.

As a preferred embodiment of the fashion personality prediction and clothing recommendation method based on social networks disclosed in present invention, where the design elements are, based on the clothing style, a design element set that can form complete clothing, and various design element sets are classified and numbered;
the garment design model comprises;
a multidimensional matrix as input: Qi={q1,q2 . . . ,qk}; and
a multidimensional dataset as output, comprising various design elements S={Si,Sj, . . . Sv}, where, Sk (k=i, j, . . . ,v) represents the classification number of the design elements set of class k.

The second aspect: the present invention provides a device for predicting fashion personality and recommending clothing based on social networks, including:
collection module, configured to obtain user language feature data in social networks;
proportion acquisition module, configured for obtaining all the proportional preferences of the user' fashion personality types based on the fashion personality test scale;
the first model construction module, configured to establish a relationship model between user language features and fashion personality types by machine learning algorithms.
style matching module, configured to extract clothing features, screen clothing samples, quantify the style of the clothing samples, and then match the design style of the clothing samples;
user preference acquisition module, configured to obtain the user's preference values for clothing sample styles;

the second model construction module, configured for prediction and recommendation by constructing a fashion design model based on the correspondence between fashion personality types and clothing style preference values, as well as the correspondence between clothing styles and design elements, combined with the user's language feature and fashion personality type relationship model.

The third aspect: the present invention provides an electronic device, including:
memory and processor;
where the memory is used for storing computer-executable instructions, and the processor is used for executing the computer-executable instructions. The computer-executable instructions, when executed by the processor, implement the steps for the fashion personality prediction and clothing recommendation method based on social networks.

The fourth aspect: the present invention provides a computer-readable storage medium storing computer-executable instructions, where the computer-executable instructions, when executed by a processor, implement the steps for the fashion personality prediction and clothing recommendation method based on social networks.

In comparison to existing technologies, the present invention effectively mines consumer fashion aesthetic preferences through social network data and provides guidance for personalized clothing design. It delivers an effective solution for big data-driven intelligent clothing design that is tailored to consumer demand. Compared to existing technologies, the present invention comprehensively and efficiently mines personalized consumer aesthetic demands, resulting in significant improvements in both logical methods and model efficacy. Through the definition of fashion personality, intelligent manufacturing can be achieved in the core segment of the clothing industry supply chain, enabling clothing enterprises to stay updated on evolving consumer demands and formulate precise marketing strategies.

### BRIEF DESCRIPTION OF THE DRAWINGS

In order to describe the technical solutions in the embodiments of the present invention more clearly, the following briefly introduces the accompanying drawings required for describing the embodiments. Apparently, the accompanying drawings in the following description show only some embodiments of the present invention, and those of ordinary skill in the art may still derive other drawings from these drawings without any creative efforts. where:

FIG. 1 is an overall schematic diagram of a fashion personality prediction and clothing recommendation method based on social networks according to one embodiment of the present invention.

FIG. 2 is a schematic diagram of the detailed process flow of a fashion personality prediction and clothing recommendation method based on social networks according to an embodiment of the present invention.

### DETAILED DESCRIPTION

In order to make the aforementioned purposes, features and advantages of the present invention more apparent and comprehensible, detailed descriptions of specific embodiments of the present invention are provided below in conjunction with the appended drawings. It is understood that the described embodiments are merely a part of the embodiments of the present invention, rather than all embodiments. Based on the embodiments of the present invention, all other embodiments obtained by those of ordinary skill in the art without creative efforts shall fall within the protection scope of the present invention.

While the following description provides numerous specific details to fully comprehend the present invention, alternative implementations not explicitly disclosed herein are also possible. Those skilled in the art can carry out similar promotions without deviating from the scope of the present invention, thus the present invention is not limited to the specific embodiments disclosed below.

Secondly, it should be noted that the term “embodiment” or “embodiments” used herein refers to a particular feature, structure, or characteristic that may be incorporated into one or more implementations of the present invention. The term “in one embodiment” in this specification does not necessarily refer to the same embodiment, nor is it solely or selectively exclusive with other embodiments in a mutual way.

The present invention is described in detail in conjunction with illustrations. For the purpose of description, sectional views of the device structure are partially enlarged without being drawn to scale. The illustrations are merely exemplary and should not limit the protection scope of the present invention. Furthermore, it is important to consider the three-dimensional spatial dimensions of length, width, and depth in actual production.

It should be noted that in the description of the present invention that terms such as “up, down, inside, and outside” indicating orientation or positional relationships are based on the orientation or positional relationships shown in the illustrations for the purpose of facilitating the description and simplifying the disclosure. They do not indicate or imply that the device or the components referred to must have a specific orientation, be constructed in a specific orientation, or operate in a specific orientation, and therefore should not be construed as limiting the present invention. Moreover, terms like “first, second or third” are only used for description, and should not be considered as a designation or designation of relative importance.

Unless otherwise explicitly specified and limited in the present invention, the terms “installation, connection, linking” should be understood in a broad sense. For example, they could refer to fixed or detachable connections, as well as integrally formed connections. They could also encompass mechanical, electrical or direct connections, indirect connections via intermediaries, and connections within two components. The terms described above have specific meanings in the present invention that can be understood by those skilled in the art in light of the particular circumstances.

### Embodiment 1

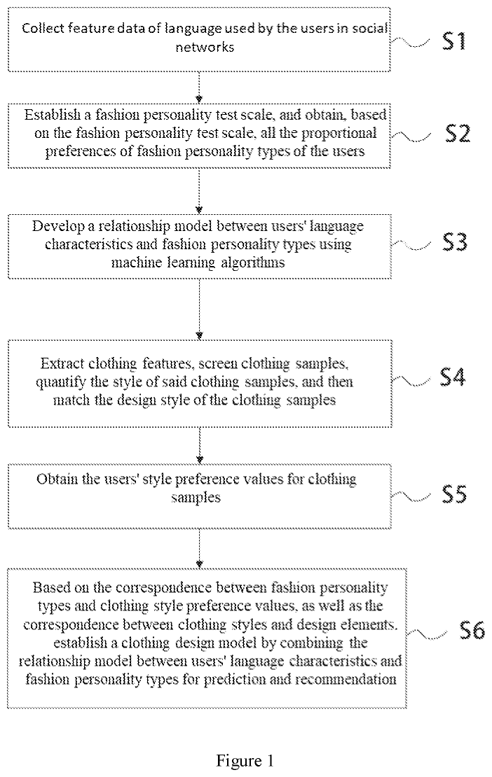

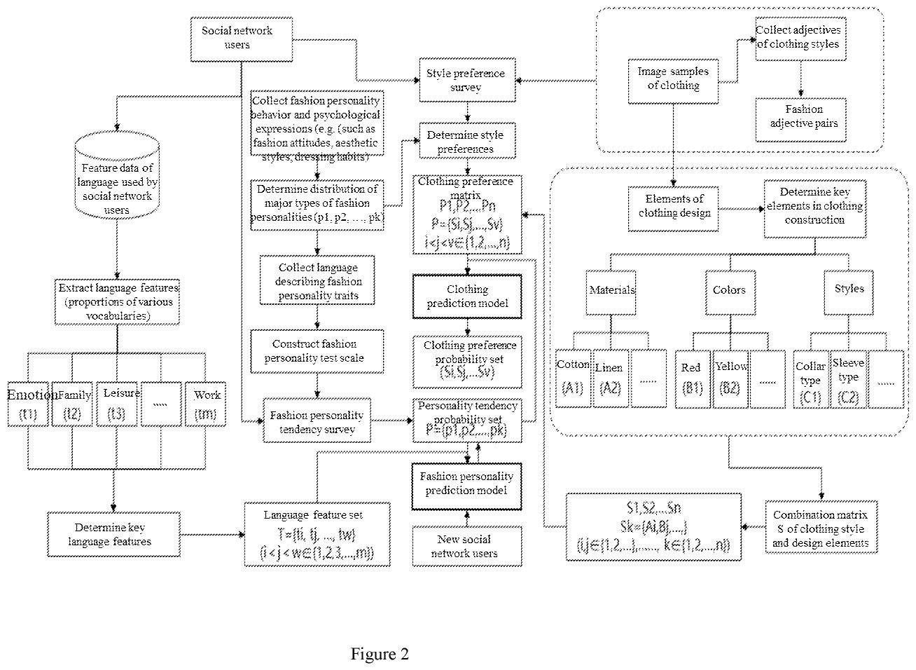

Referring to FIG. 1-2, an embodiment of the present invention provides a fashion personality prediction and clothing recommendation method based on social networks, where the method includes:
S1: collecting feature data of language used by the users in social networks, where
it should be noted that user language feature data includes text and symbols uploaded by users, such as public texts from WeChat moments, Weibo tweets, etc., which can be obtained through various big data collection algorithms, such as web crawling algorithms.
S2: establishing a fashion personality test scale and obtaining, based on the fashion personality test scale, all the proportional preferences of fashion personality types of the users;

Further, establishing a fashion personality test scale includes:
collecting a large number of daily product images related to fashion, and generating personality-based descriptive vocabulary expressing fashion styles based on the images; where
it should be noted that daily products may include clothing, art pieces, automobiles, etc. The methods to generate vocabularies include but are not limited to expert judgment and inviting experts to generate personality descriptors from an “aesthetic sense” perspective based on images, defining them as fashionable personality traits, and then screening the descriptors.

After screening all the personality-related vocabularies, classifying all the personality-related vocabularies by clustering algorithm combined with semantics, where each type corresponds to a fashion personality type, represented by p1, p2, . . . pk;

Specifically, the fashion personality type may include, for example, a refined type, a rational type, a novel type, and the like.

A series of fashion personality assessment questions based on text and images are designed to explore the specific behaviors and psychological expressions of users with different fashion personalities in fashion-related activities. Through significant difference analysis and reliability and validity testing, items that have discriminatory power for personality identification are selected to form a fashion personality test scale.

It is important to note that specific behaviors and psychological expressions encompass components such as fashion perception, sensitivity, aesthetic attitude, style, and more. The test questions can be developed through a variety of psychological research methods, such as expert interviews, consumer questionnaires, brainstorming sessions, and others.

Furthermore, the obtaining, based on the fashion personality test scale, all the proportional preferences of fashion personality types of the users, includes:
obtaining the first score set by scoring each personality type using the fashion personality test scale; and

It should be noted that the fashion personality test scale is developed based on existing personality theories and is determined through evaluations by experts and consumers to identify different types of fashion personalities, such as refined type, rational type, and innovative type. Each fashion personality type corresponds to a certain number of test questions, including judgment questions and multiple choice questions.

Comparing the scores of each personality type within the first score set with the number of questions to obtain the proportional preferences of fashion personality types P={p1,p2, . . . pk}.

It should be noted that, for example, each question corresponds to 1 point, and the user's score is tallied for each fashion personality type test. For instance, if there are a total of 15 questions for the refined type and the user scores 12 points, then the tendency towards that fashion personality type would be 12/15=0.8. Similarly, this user's tendencies towards other fashion personality types are calculated, and the final result of the user's fashion personality test is represented as P={p1,p2, . . . ,pk}.

Furthermore, before the establishing the model for the relationship between user language characteristics and fashion personality types using machine learning algorithms, further includes:
obtaining a set of first-personality language feature elements (m) by combining the emotional word dictionary, based on the user's language words count, where
it should be noted that the emotional word dictionary includes a large number of words with clear type tags, such as work-related, health-related, leisure-related, cognitive-related, emotional-related, and so on. One way to obtain set “m” is to calculate the proportion of various categories of vocabulary in each user's text and use these categories as language features related to personality;
obtaining the correlation coefficients between the personality language feature elements of users and the fashionable personality types, and filtering out personality language feature elements with strong correlation coefficient,
where the personality language feature elements with strong correlation coefficient are used to establish the relationship model, and
it is worth mentioning that the relevant correlation coefficient can be calculated and statistically analyzed using Pearson correlation.

Further, the personality language feature elements with strong correlation coefficients are screened, including,
reserving the feature elements involved in correlation coefficients greater than the first threshold as the key language feature set for fashion personality prediction index, expressed as:

$$T = \{ ti , tj , … , tw \} ( i < j < w ∈ \{ 1 , 2 , 3 , … , m \} )$$

that is, among m language feature elements, there are w (w<m) feature elements that have a strong correlation with fashion personality types.

It is significant to state that the feature elements with strong correlation coefficients should be retained in order to extract the main influencing factors. Generally, related factors with correlation coefficients greater than or equal to 0.6 are extracted. If the correlation coefficient between work-related vocabulary and fashion personality tendency is found to be small (less than 0.4), then that feature should be removed.

The Pearson correlation coefficient is commonly denoted by the symbol ‘r’, and its calculation formula and possible range are as follows:

$$r = \frac{{\sum }_{i = 1}^{n} ( {x}_{i} - \overline{x} ) ( {y}_{i} - \overline{y} )}{\sqrt{{\sum }_{i = 1}^{n} {( {x}_{i} - \overline{x} )}^{2} {\sum }_{i = 1}^{n} {( {y}_{i} - \overline{y} )}^{2}}}$$

Where, xᵢ and yᵢ; denote the values of sample i on variables x and y, respectively. x̅and y̅denote the mean values of all samples on variables x and y, respectively. The range of values for the correlation coefficient r: −1≤r≤1; where,

$$\{ \begin{matrix}0.8 < r < 1 , extremely strong correlation \\ 0.6 < r < 0.8 , strong correlation \\ 0.4 < r < 0.6 , weak correlation \\ 0 < r < 0.4 , extremely weak correlation or uncorrelated\end{matrix}$$

S3: developing a relationship model between users' language characteristics and fashion personality types using machine learning algorithms;

Furthermore, the developing a relationship model between users' language characteristics and fashion personality types, including,
the input data is the key language features set Ti={t1, t2, . . . , tw}; and
the output data is a multidimensional matrix Qi={q1,q2 . . . ,qk}, where
the multidimensional matrix Qi={q1,q2, . . . ,qk} corresponds to the proportional preferences of personality types P={p1,p2, . . . pk}.

It should be noted that the machine learning algorithm may include Random Forest, SVM (Support Vector Machine). The established model is a multi-input and multi-output predictive model, where both input and output variables are numerical variables between 0 and 1. Compared to traditional statistical methods, this type of algorithm has a lower requirement for sample size and performs well when processing input samples with high-dimensional features, making it more suitable for this method.

S4: extracting clothing features, screening clothing samples, quantifying the style of clothing samples, and then matching the design style of the clothing samples, where
it is significant to state that before extracting clothing features and selecting clothing samples, a large number of clothing images will be collected. Several experts with background in the clothing industry will be invited to perform style extraction and classification, identifying common fashion style adjectives such as traditional—avant-garde, sporty—casual, and so on. Based on this, experts will screen the images and select representative clothing samples that cover as many common clothing styles on the market as possible.

Furthermore, the fashion style of clothing samples will be quantified to match the design style of clothing samples.

A specific example could be: Experts are invited to conduct subjective evaluation experiments based on selected clothing style adjectives and their corresponding samples. Specifically, experts will score the above adjectives for each image to obtain the tendency of each sample in various stylistic dimensions.

Using nine-level semantic scale to score the style of clothing samples;

Specifically, for example, take the “traditional—avant-garde” as an example, the scale is designed as follows:

TABLE 1
Clothing style evaluation scale

| | Style adjectives | | | | | | | | |
|---|---|---|---|---|---|---|---|---|---|
| | Extremely | Very | | Slightly | | Slightly | Avant- | Very | Extremely |
| | traditional | traditional | Traditional | traditional | Neutral | avant-garde | garde | avant-garde | avant-garde |
| Rating | −4 | −3 | −2 | −1 | 0 | 1 | 2 | 3 | 4 |

using, based on score statistics, triangular fuzzy numbers to characterize the style of various clothing samples, and calculating the degree of proximity, expressed as:

$$= ( \frac{{\sum }_{k = 1}^{n} {A}_{i j k 1}}{n} , \frac{{\sum }_{k = 1}^{n} {A}_{i j k 2}}{n} , \frac{{\sum }_{k = 1}^{n} {A}_{i j k 3}}{n} , )$$

where n represents the total number of experts participating in the evaluation, i denotes different clothing samples, and j represents pairs of adjectives for different clothing styles.

$${U}_{T} ( ) = \frac{ai - l}{m - l} + \frac{1}{2} \vert \frac{d i - a i}{( m - l ) + ( d i - a i )} - \frac{a i - c i}{( m - l ) + ( a i - c i )} \vert$$

where, [symbol] =(ci, ai, di), i=1,2, . . . ,n; U_{T}( [symbol] ) represents the overall utility value of a triangular fuzzy number; n is the total number of experts participating in the experiment, and m and l are the upper and lower limits of the triangular fuzzy numbers, respectively;

$${S}_{T} ( ) = \frac{{∪}_{T} ( \tilde{A} ) \cdot {U}_{T} ( \tilde{B} )}{max ( {U}_{T} ( \tilde{A} ) \cdot {U}_{T} ( \tilde{A} ) , {U}_{T} ( \tilde{B} ) \cdot {U}_{T} ( \tilde{B} ) )}$$

where, U_{T}(Ã) represents the overall utility value corresponding to the triangular fuzzy number Ã, U_{T}(\tilde{B})represents the overall utility value corresponding to the triangular fuzzy number \tilde{B}, and S_{T}( [symbol] ) denotes the proximity between A and B, i.e., the degree of closeness between the clothing sample and the clothing style.

It should also be noted that the aforementioned triangular fuzzy numbers are a method of converting fuzzy and uncertain linguistic variables into definite values. The specific definition is as follows:
if the fuzzy number Ã can be determined by (al, am, au), al≤am≤au; where, al, am, au are all real numbers, then the membership function is:

$${μ}_{\tilde{A}} ( x ) = \{ \begin{matrix}\frac{x - al}{am - al} , & al \leq x \leq a m \\ \frac{x - a u}{am - a u} , & am \leq x \leq a u \\ 0 , & \end{matrix}$$

Ã is referred to as a triangular fuzzy number, denoted as Ã=(al, am, au); where, al, am, au represent the minimum value, the median value and the maximum value of the triangular fuzzy number respectively.

According to the nine-level semantic scale used above, the triangle fuzzy numbers corresponding to the evaluation languages at each level are shown in Table 2 (taking traditional—avant-garde as an example).

TABLE 2
Semantic scale corresponding to triangular fuzzy number

| Evaluation language | Triangular fuzzy number |
|---|---|
| Extremely traditional | (0, 0, 0.125) |
| Very traditional | (0, 0.125, 0.25) |
| Traditional | (0.125, 0.25, 0.375) |
| Slightly traditional | (0.25, 0.375, 0.5) |
| Neutral | (0.375, 0.5, 0.625) |
| Slightly avant-garde | (0.5, 0.625, 0.75) |
| Avant-garde | (0.625, 0.75, 0.875) |
| Very avant-garde | (0, 75, 0.875, 1) |
| Extremely avant-garde | (0.875, 1, 1) |

S5: obtaining the users' style preference values for clothing samples, where
the preferred method is to invite the same group of users to participate in a clothing preference survey based on clothing samples, that is, for each piece of clothing, the users grade it based on how much they like it. In combination with the style type of each clothing, the user's clothing style preferences are obtained. A five-level rating scale is adopted in this round, as shown in Table 3:

TABLE 3
Evaluation scale for clothing preference

| | | | Like it very | Extremely like |
|---|---|---|---|---|
| Dislike | Slightly like it | Prefer | much | it |
| 1 point | 2 point | 3 point | 4 point | 5 point |

S6: based on the correspondence between fashion personality types and clothing style preference values, as well as the correspondence between clothing styles and design elements, establishing a clothing design model by combining the relationship model between the users' language characteristics and fashion personality types for prediction and recommendation.

Furthermore, the design elements should be based on clothing styles to form a collection of design elements that can constitute a complete garment, and each collection of design elements should be classified and numbered by category.

The preferred method is to collect the design elements of clothing such as colors, fabrics, styles through literature search, expert interviews, and other methods. The experts with background in the clothing industry should be invited to determine design elements (including fabric, color, style (collar type, sleeve type, top length, sleeve length, silhouette, etc.)) that can reflect various clothing styles and form a complete garment, and code these design elements, e.g. fabric (A1, A2, . . . ), color (B1, B2, . . . ), style (C1, C2, C3, . . . ) and so on.

A clothing design model, including,
a multidimensional matrix as input: Qi={q1,q2 . . . ,qk}; and
a multidimensional dataset as output, including various design elements S={Si,Sj, . . . Sv}; where, Sk represents the classification number of various design elements. Specifically, Sk refers to a specific subset of multidimensional dataset S, where k can be i, j, . . . v. For example, clothing includes multiple design categories such as color, fabric, and style. Assuming Si represents color, then Si={red, orange, yellow, . . . }. And if Sj represents material, then Sj={cotton, linen, silk, . . . }.

It should be noted that the model is capable of recommending corresponding clothing designs based on different fashion personalities. Given the complexity of input and output data and limited clothing samples, a machine learning algorithm with low sample requirements and high predictive accuracy is still employed in this process. The integrated method comprises of two sub-models, namely the fashion personality prediction model and the clothing design recommendation model. By utilizing this method and model, personalized clothing design solutions corresponding to the language features of a user on social networks can be obtained, and at the same time, the user's fashion personality type can also be identified.

The above is a schematic scheme of a fashion personality prediction and clothing recommendation method based on social networks for this embodiment. It needs to be explained that the technical solution of the device for predicting fashion personality and recommending clothing based on social networks is based on the same concept as that of the fashion personality prediction and clothing recommendation method based on social networks described above. For detailed contents of the technical solution for the device for predicting fashion personality and recommending clothing based on social networks in this embodiment that are not fully described, refer to the description of the corresponding method's technical solution mentioned above.

In this embodiment, the device for predicting fashion personality and recommending clothing based on social networks includes:
collection module, configured to obtain user language feature data in social networks;
proportion acquisition module, configured for obtaining all the proportional preferences of the user' fashion personality types based on the fashion personality test scale;
the first model construction module, configured to establish a relationship model between user language features and fashion personality types by machine learning algorithms.
style matching module, configured to extract clothing features, screen clothing samples, quantify the style of the clothing samples, and then match the design style of the clothing samples;
user preference acquisition module, configured to obtain the user's preference values for clothing sample styles;
second model construction module, configured for prediction and recommendation by constructing a fashion design model based on the correspondence between fashion personality types and clothing style preference values, as well as the correspondence between clothing styles and design elements, combined with the user's language feature and fashion personality type relationship model.

This embodiment also provides a computing device suitable for calculating accumulated climbing height, comprising:

Memory and processor; the memory is used to store computer-executable instructions, and the processor is used to execute the computer-executable instructions, so as to implement the fashion personality prediction and clothing recommendation method based on social networks as described in the above embodiment.

This embodiment also provides a storage medium on which a computer program is stored. When executed by the processor, the program implements the fashion personality prediction and clothing recommendation method based on social networks proposed in the above embodiment.

The storage medium proposed in this embodiment is based on the same concept as that of the fashion personality prediction and clothing recommendation method based on social networks described above. Refer to the above embodiment for technical details that are not described in detail in this embodiment. Moreover, this embodiment shares the same advantageous effect as the above embodiment.

Based on the above description of the embodiments, those skilled in the relevant field can clearly understand that the present invention can be implemented using software and necessary generic hardware, although it can also be implemented through hardware, the former is often a preferable method. Based on this understanding, the essential or contributory aspects of the technical solution of the present invention can be embodied in the form of a software product, which can be stored in computer-readable storage media such as floppy disks, read-only memory (ROM), random-access memory (RAM), flash drives, hard drives, or CD-ROMs. The software product includes several instructions to enable a computer device (including personal computers, servers, network devices, etc.) to execute the various embodiments of the present invention.

### Embodiment 2

Referring to Table 4, an embodiment of the present invention provides a fashion personality prediction and clothing recommendation method based on social networks. In order to verify its beneficial effects, a comparative demonstration with traditional methods is provided.

TABLE 4
Comparison

| | Source of data | Data mining mode | Mechanism |
|---|---|---|---|
| Traditional | Relying on | Consumer | It often results in unsatisfactory |
| method | after-sales data: | preference data is | recommendation performance, |
| | Official or shopping | subjective and | due to lack of exploration into the |
| | APP background data | ambiguous | intricate cognitive mechanisms |
| | | | underlying consumer preferences. |
| Optimization | Implicit and | Big data and | From a psychological perspective |
| method | authentic information | artificial intelligence | and in combination with a |
| | on social networks | algorithms | personality model, the present |
| | | | invention thoroughly analyzes the |
| | | | consumer's cognitive model to |
| | | | establish a consumer personality |
| | | | system oriented towards fashion. |

According to Table 4, our advantage lies in utilizing big data technology to mine users' daily behavior data on social networks, extracting personalized features of fashion consumers from it; constructing a personality tendency discrimination system for the fashion field based on cognitive psychology to obtain more stable and accurate user preferences; combining expert perceptual evaluation, integrating clothing design expertise with consumer personality traits and demands, utilizing artificial intelligence recommendation algorithms to carry out highly matching intelligent design and recommendation of clothing.

In general, the present invention involves utilizing big data analysis techniques to deeply explore users' behavior characteristics on social networks. This includes personal text data such as life sharing, opinions, and attitudes posted by users on platforms such as Weibo, WeChat (Moments), and Xiaohongshu. The present invention combines personality trait theory (referring to the Big Five personality traits and Enneagram) to construct a fashion personality discrimination system around dimensions such as personal fashion attitude, fashion perception, and aesthetic preferences. Then, the present invention extracts the main feature factors that influence users' fashion personality from social network text data to build a fashion personality prediction model. Focusing on the field of clothing, it obtains user preference data, including clothing styles, designs, colors, and fabrics, through methods such as sensory evaluation and fuzzy mathematics. It constructs a clothing preference prediction model using machine learning algorithms. Finally, incorporating professional knowledge of designers, it provides corresponding clothing product recommendations.

It should be noted that the above embodiments are only intended to illustrate the technical solution of the present invention and not to limit it. Although the preferred embodiments have been described in detail, those skilled in the art should understand that modifications or equivalent substitutions may be made to the technical solution of the present invention without departing from its essence and scope, which are all within the scope of the claims of the present invention.

What is claimed is:

1. A fashion personality prediction and clothing recommendation method based on social networks, comprising:
collecting feature data of language used by the users in social networks;
establishing a fashion personality test scale, and obtaining the fashion personality test scale, all the proportional preferences of fashion personality types of the users;
developing a relationship model between users' language characteristics and fashion personality types using machine learning algorithms;
extracting clothing features, screening clothing samples, quantifying the style of said clothing samples, and then matching the design style of the clothing samples;
obtaining the users' style preference values for clothing samples; and
based on the correspondence between fashion personality types and clothing style preference values, as well as the correspondence between clothing styles and design elements, establishing a clothing design model by combining the relationship model between users' language characteristics and fashion personality types for prediction and recommendation.

2. The fashion personality prediction and clothing recommendation method based on social networks according to claim 1, wherein before the establishing a relationship model between users' language characteristics and fashion personality types using machine learning algorithms further comprises:
obtaining a set of first-personality language feature elements (m) by combining the number of words used by the users in different types of social text and an emotion dictionary; and
obtaining the correlation coefficients between the personality language feature elements of users and the fashionable personality types, and filtering out personality language feature elements with strong correlation coefficient, wherein
the personality language feature elements with strong correlation coefficient are used to establish the relationship model.

3. The fashion personality prediction and clothing recommendation method based on social networks according to claim 2, wherein the establishing a fashion personality test scale comprises:
collecting a large number of daily product images related to fashion, and generating personality- based descriptive vocabulary expressing fashion styles based on the images;
after screening all the personality-related vocabularies, classifying all the personality-related vocabularies by clustering algorithm combined with semantics, wherein each type corresponds to a fashion personality type, represented by p1, p2, . . . pk;
designing a series of fashion personality assessment questions based on text and images to explore the specific behaviors and psychological expressions of users with different fashion personalities in fashion-related activities, selecting, through significant difference analysis and reliability and validity testing, items that have discriminatory power for personality identification to form a fashion personality test scale;
furthermore, the obtaining, based on the fashion personality test scale, all the proportional preferences of fashion personality types of the users, comprising:
obtaining the first score set by scoring each personality type using the fashion personality test scale; and
comparing the scores of each personality type within the first score set with the number of questions to obtain the proportional preferences of fashion personality types P={p1,p2, . . . pk}.

4. The fashion personality prediction and clothing recommendation method based on social networks as described in claim 2, wherein the filtering out personality language feature elements with strong correlation coefficient, comprises:
reserving the feature elements involved in correlation coefficients greater than the first threshold as the key language feature set for fashion personality prediction index, expressed as:
$$T = \{ ti , tj , … , tw \} ( i < j < w ∈ \{ 1 , 2 , 3 , … , m \} )$$
that is, among m language feature elements, there are w (w<m) feature elements that have a strong correlation with fashion personality types.

5. The fashion personality prediction and clothing recommendation method based on social networks of claim 4, wherein the developing a relationship model between users' language characteristics and fashion personality types, comprises that:
the input data is the key language features set Ti={t1, t2, . . . , tw}; and
the output data is a multidimensional matrix Qi={q1,q2 . . . ,qk}, wherein
the multidimensional matrix Qi={q1, q2, . . . , qk} corresponds to the proportional preferences of personality types P={p1, p2, . . . , pk}.

6. The fashion personality prediction and clothing recommendation method based on social networks as described in claim 5, wherein the quantifying the style of clothing samples and then matching the design style of clothing samples, comprising:
using nine-level semantic scale to score the style of clothing samples;
using, based on score statistics, triangular fuzzy numbers to characterize the style of various clothing samples, and calculating the degree of proximity, expressed as:
$$= ( \frac{{\sum }_{k = 1}^{n} {A}_{i j k 1}}{n} , \frac{{\sum }_{k = 1}^{n} {A}_{i j k 2}}{n} , \frac{{\sum }_{k = 1}^{n} {A}_{i j k 3}}{n} , )$$
wherein n represents the total number of experts participating in the evaluation, i denotes different clothing samples, and j represents pairs of adjectives for different clothing styles.
$${U}_{T} ( ) = \frac{a i - l}{m - l} + \frac{1}{2} \vert \frac{d i - a i}{( m - l ) + ( d i - a i )} - \frac{a i - c i}{( m - l ) + ( a i - c i )} \vert$$
wherein, [symbol] =(ci, ai, di), i=1,2, . . . ,n; U_{T}( [symbol] ) represents the overall utility value of a triangular fuzzy number; n is the total number of experts participating in the experiment, and m and l are the upper and lower limits of the triangular fuzzy numbers, respectively;
$${S}_{T} ( ) = \frac{{U}_{T} ( \tilde{A} ) \cdot {U}_{T} ( \tilde{B} )}{max ( {U}_{T} ( Ã ) \cdot {U}_{T} ( \tilde{A} ) , {U}_{T} ( \tilde{B} ) \cdot {U}_{T} ( \tilde{B} ) )}$$
wherein, U_{T}(Ã) represents the overall utility value corresponding to the triangular fuzzy number Ã, U_{T}(\tilde{B})represents the overall utility value corresponding to the triangular fuzzy number \tilde{B}, and S_{T}( [symbol] ) denotes the proximity between A and B, i.e., the degree of closeness between the clothing sample and the clothing style.

7. The fashion personality prediction and clothing recommendation method based on social networks according to claim 5, wherein the design elements are, based on the clothing style, a design element set that can form complete clothing, and various design element sets are classified and numbered;
the garment design model comprises;
a multidimensional matrix as input: Qi={q1,q2 . . . ,qk}; and
a multidimensional dataset as output, comprising various design elements S={Si,Sj, . . . Sv}, wherein, Sk (k=i, j, . . . ,v) represents the classification number of the design elements set of class k.

8. A device for predicting fashion personality and recommending clothing based on social networks, comprising:
collection module, configured to obtain user language feature data in social networks;
proportion acquisition module, configured for obtaining all the proportional preferences of the user' fashion personality types based on the fashion personality test scale;
the first model construction module, configured to establish a relationship model between user language features and fashion personality types by machine learning algorithms;
style matching module, configured to extract clothing features, screen clothing samples, quantify the style of the clothing samples, and then match the design style of the clothing samples;
user preference acquisition module, configured to obtain the user's preference values for clothing sample styles;
the second model construction module, configured for prediction and recommendation by constructing a fashion design model based on the correspondence between fashion personality types and clothing style preference values, as well as the correspondence between clothing styles and design elements, combined with the user's language feature and fashion personality type relationship model.

9. An electronic device, comprising:
memory and processor, wherein
the memory is used for storing computer-executable instructions, and the processor is used for executing the computer-executable instructions. The computer-executable instructions, when executed by the processor, implement any of the steps described in claim 1 for the fashion personality prediction and clothing recommendation method based on social networks.

10. A computer-readable storage medium storing computer-executable instructions, wherein the computer-executable instructions, when executed by a processor, implement any of the steps described in claim 1 for the fashion personality prediction and clothing recommendation method based on social networks.

11. The fashion personality prediction and clothing recommendation method based on social networks according to claim 6, wherein the design elements are, based on the clothing style, a design element set that can form complete clothing, and various design element sets are classified and numbered;
the garment design model comprises;
a multidimensional matrix as input: Qi={q1,q2 . . . ,qk}; and
a multidimensional dataset as output, comprising various design elements S={Si,Sj, . . . Sv}, wherein, Sk (k=i, j, . . . ,v) represents the classification number of the design elements set of class k.

12. The fashion personality prediction and clothing recommendation method based on social networks as described in claim 3, wherein the filtering out personality language feature elements with strong correlation coefficient, comprises:
reserving the feature elements involved in correlation coefficients greater than the first threshold as the key language feature set for fashion personality prediction index, expressed as:
$$T = \{ ti , tj , … , tw \} ( i < j < w ∈ \{ 1 , 2 , 3 , … , m \} )$$
that is, among m language feature elements, there are w (w<m) feature elements that have a strong correlation with fashion personality types.

13. The fashion personality prediction and clothing recommendation method based on social networks of claim 12, wherein the developing a relationship model between users' language characteristics and fashion personality types, comprises that:
the input data is the key language features set Ti={t1, t2, . . . , tw}; and
the output data is a multidimensional matrix Qi={q1,q2 . . . ,qk}, wherein
the multidimensional matrix Qi={q1, q2, . . . , qk} corresponds to the proportional preferences of personality types P={p1, p2, . . . , pk}.

14. The fashion personality prediction and clothing recommendation method based on social networks as described in claim 13, wherein the quantifying the style of clothing samples and then matching the design style of clothing samples, comprising:
using nine-level semantic scale to score the style of clothing samples;
using, based on score statistics, triangular fuzzy numbers to characterize the style of various clothing samples, and calculating the degree of proximity, expressed as:
$$= ( \frac{{\sum }_{k = 1}^{n} {A}_{i j k 1}}{n} , \frac{{\sum }_{k = 1}^{n} {A}_{i j k 2}}{n} , \frac{{\sum }_{k = 1}^{n} {A}_{i j k 3}}{n} , )$$
wherein n represents the total number of experts participating in the evaluation, i denotes different clothing samples, and j represents pairs of adjectives for different clothing styles.
$${U}_{T} ( ) = \frac{a i - l}{m - l} + \frac{1}{2} \vert \frac{d i - a i}{( m - l ) + ( d i - a i )} - \frac{a i - c i}{( m - l ) + ( a i - c i )} \vert$$
wherein, [symbol] =(ci, ai, di), i=1,2, . . . ,n; U_{T}( [symbol] ) represents the overall utility value of a triangular fuzzy number; n is the total number of experts participating in the experiment, and m and l are the upper and lower limits of the triangular fuzzy numbers, respectively;
$${S}_{T} ( ) = \frac{{U}_{T} ( \tilde{A} ) \cdot {U}_{T} ( \tilde{B} )}{max ( {U}_{T} ( Ã ) \cdot {U}_{T} ( \tilde{A} ) , {U}_{T} ( \tilde{B} ) \cdot {U}_{T} ( \tilde{B} ) )}$$
wherein, U_{T}(Ã) represents the overall utility value corresponding to the triangular fuzzy number Ã, U_{T}(\tilde{B})represents the overall utility value corresponding to the triangular fuzzy number \tilde{B}, and S_{T}( [symbol] ) denotes the proximity between A and B, i.e., the degree of closeness between the clothing sample and the clothing style.

15. The fashion personality prediction and clothing recommendation method based on social networks according to claim 13, wherein the design elements are, based on the clothing style, a design element set that can form complete clothing, and various design element sets are classified and numbered;
the garment design model comprises;
a multidimensional matrix as input: Qi={q1,q2 . . . ,qk}; and
a multidimensional dataset as output, comprising various design elements S={ Si,Sj, . . . Sv}, wherein, Sk (k=i, j, . . . ,v) represents the classification number of the design elements set of class k.

16. The fashion personality prediction and clothing recommendation method based on social networks according to claim 14, wherein the design elements are, based on the clothing style, a design element set that can form complete clothing, and various design element sets are classified and numbered;
the garment design model comprises;
a multidimensional matrix as input: Qi={q1,q2 . . . ,qk}; and
a multidimensional dataset as output, comprising various design elements S={Si, Sj, . . . Sv}, wherein, Sk (k=i, j, . . . ,v) represents the classification number of the design elements set of class k.
